(19) United States
(12) Patent Application Publication
(10) Pub. No.: US 2022/0056937 A1
(43) Pub. Date: Feb. 24, 2022

(54) PARTITION MOUNTING DEVICE AND METHOD OF MANUFACTURING THE SAME

(71) Applicant: Quorum Group, LLC., Medina, NY (US)

(72) Inventors: Kurt William Lyons, Rochester, NY (US); Jesse Jay Follman, Albion, NY (US)

(21) Appl. No.: 17/119,395

(22) Filed: Dec. 11, 2020

Related U.S. Application Data
(60) Provisional application No. 63/067,216, filed on Aug. 18, 2020.

(51) Int. Cl. F16B 2/20; E04B 2/74

(52) U.S. Cl. CPC F16B 2/20; E04B 2002/7461; E04B 2/7405

(57) ABSTRACT

A partition mounting device, comprising a body, a pair of arms extending upwardly from the body, a pair of legs extending downwardly from the middle body, an upper trapezoidal-shaped channel formed between and by the pair of arms, and, a lower trapezoidal-shaped channel formed between and by the pair of legs.

### FIELD

The present invention relates generally to a partition mounting device arranged to secure privacy, social distancing and sanitary dividers to desks, cubicle partitions and other office furniture. The present invention also relates to a method of manufacturing a partition mounting device.

### BACKGROUND

In early 2020, SARS-CoV-2 spread worldwide, forcing many states in the United States to institute lock-down protocols. Those protocols resulted in the closing of many offices and businesses, requiring employees to work remotely. During the late spring and early summer of 2020, some states began allowing allow employees to return to physical offices so long as safety measures were instituted following OHSA's Guidance for Preparing Workplaces for COVID-19: https.//www.osha.gov/Publications/OSHA3990.pdf.

One of OHSA's guidelines recommended the installation of physical barriers, either temporary, e.g., plexiglass panels, or permanent, e.g., walls. Due to the low cost of plexiglass, many business owners installed temporary fixtures to hold the plexiglass panels. Some of these options included simple 2×4 mounts, hanging panels from the ceiling by wires or string, or creating floor stands to provide barriers for open-concept offices.

A problem with these options is that they are normally unsightly, clunky, and are not designed for adjustability to accommodate changes that may occur in an office layout.

Thus, there is a long felt need for a partition mounting device that sturdily secures partition panels to various types of office furniture, and presents a minimalist and aesthetically pleasing appearance while still allowing quick and easy adjustments to partition configurations.

### SUMMARY

In a preferred embodiment, the present invention broadly comprises a partition mounting device having a body, a pair of arms extending upwardly from the body, a pair of legs extending downwardly from the body, an upper trapezoidal-shaped channel formed between and by the pair of arms, and a lower trapezoidal-shaped channel formed between and by the pair of legs.

In an alternative embodiment the present invention broadly comprises a partition mounting device, comprising a middle section, a pair of arms extending upwardly from the middle section, a pair of legs extending perpendicularly from the middle section, an upper trapezoidal-shaped channel formed between and by the pair of arms, and, a perpendicular trapezoidal-shaped channel formed between and by the pair of legs.

In a further alternative embodiment the present invention broadly comprises a partition mounting stand, comprising a partition and a partition mounting device, wherein the partition mounting device comprises a body, a pair of arms extending upwardly from the body, a pair of legs extending outwardly from the body, a pair of feet extending perpendicularly outward from the pair of legs, a v-shaped channel formed between and by the pair of arms and arranged to hold and secure the partition, and a locking collar arranged to slidably engage the V-shaped channel at the distal end compressing the V-shaped channel to contact the partition.

The invention also includes a method of manufacturing a partition mounting device, comprising the steps of sending an installation kit to an end-user of the mounting device, the kit including an illustration of a typical workstation to be outfitted with one or more partitions, the illustration containing fields for the end-user to enter certain workstation dimensions, and, a pair of calipers; the method further including the steps of measuring thickness of a partition to which the partition mounting device will be affixed with the pair of calipers, where the measuring is performed by the end-user, photographing the pair of calipers in place while measuring the thickness of the partition to which the partition mounting device will be affixed, where the photographing is performed by the end-user, receiving the dimensions, measurements and photograph(s) from the end-user, and, manufacturing the partition mounting device according to dimensions and measurements provided by the end-user.

A primary object of the present invention is to provide a device that temporarily secures partition panels to office desks and cubicle walls.

A secondary object of the present invention is to provide a device that temporarily secures partition panels and is easily assembled, disassembled, and reconfigured.

A further object of the present invention is to provide a minimalist and single-piece device that temporarily secures partition panels to office desks and cubicle walls.

Another object of the present invention is to provide for a plurality of the devices to be combined with a variety of sized partitions or a plurality of partitions to accommodate the needs of various office configurations.

Yet another object of the present invention is to provide for a standalone partition barrier holder comprised of a singular piece that also includes a locking mechanism.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 shows a front view of a first embodiment of the present invention;

FIG. 2 shows a front view of a second embodiment of the present invention;

FIG. 3 shows a perspective view of the present invention in FIG. 1 attaching a partition barrier to a cubicle wall barrier; and,

FIG. 4 shows a front view of a third embodiment of the present invention.

### DETAILED DESCRIPTION

At the outset, it should be appreciated that like drawing numbers on different drawing views identify identical, or functionally similar, structural elements. It is to be understood that the claims are not limited to the disclosed aspects. It should be appreciated that, although the disclosed partition mounting device embodiments of the present invention finds particular application on a cubicle wall barrier and a desktop, that the invention likely has applications in other locations as well. For example, the invention could be used anywhere in an office setting where it is necessary to provide physical barriers as recommended by OSHA in view of SARS-CoV-2, e.g., bar tops, cashier or point of sale counters, reception desks, etc.

Furthermore, it is understood that this disclosure is not limited to the particular methodology, materials and modifications described and as such may, of course, vary. It is also understood that the terminology used herein is for the purpose of describing particular aspects only and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims.

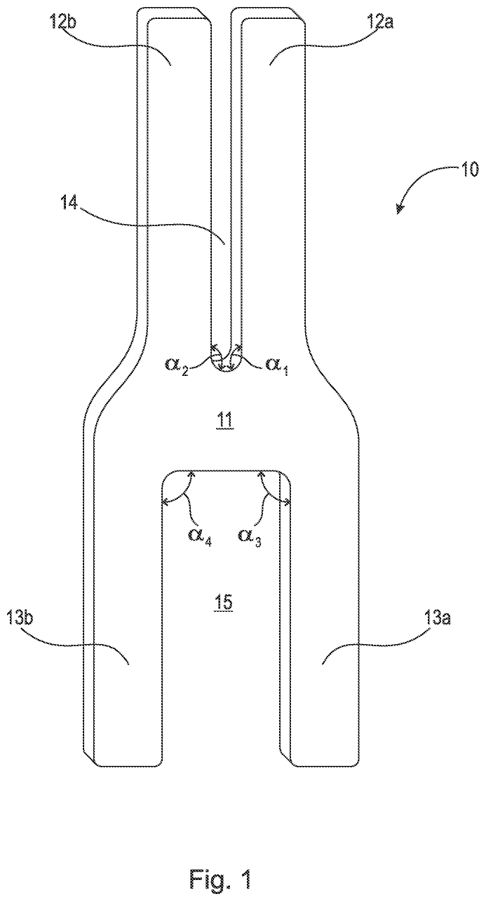

Adverting to the figures, FIG. 1 is a front side view of a first embodiment of the present invention. Partition mounting device 10 is preferably configured to frictionally attach to the top of a cubicle barrier wall (i.e., a partition); however, varying the width of the below-described channel allows partition mounting device 10 to adapt to a variety of barrier or wall structures.

Partition mounting device 10 comprises body 11, arms 12a and 12b, and legs 13a and 13b. In a preferred embodiment, body 11, arms 12a and 12b, and legs 13a and 13b comprise a single piece. The inside surfaces of first arm 12a and second arm 12b of partition mounting device 10 forms upper trapezoidal channel 14. The distal ends of arms 12a and 12b are spaced apart at a shorter distance than the proximal ends fixedly secured to body 11. The distal end of channel 14 forms a rounded end that has a center point. In a preferred embodiment, angle α1 is 89° and is formed from the inside surface of arm 12a and the midpoint of channel 14 rounded end. In a preferred embodiment, angle α2 is 89° and is formed by the inside surface of arm 12b and the midpoint of channel 14 rounded end. Legs 13a and 13b of partition mounting device 10 inside surface forms lower trapezoidal channel 15. The distal ends of legs 13a and 13b are spaced apart at a shorter distance than the proximal ends fixedly secured to body 11. In a preferred embodiment, angle α3 is 88° and is formed by the inside surface of leg 13a and the proximal inside surface of channel 15. In a preferred embodiment, angle α4 is 88° and is formed by the inside surface of leg 13b and the proximal inside surface of channel 15. Lower trapezoidal channel 15 is operatively arranged to slidably engage a cubicle barrier wall top surface contacting the lower surface of body 11. The distal ends of legs 13a and 13b create a greater force of friction on both sides of cubicle barrier compare to the proximal ends of legs 13a and 13b. Upper trapezoidal channel 14 is operatively arranged to accept and engage a partition barrier slot with a preferable width substantially the same of body 11 depth. It should be appreciated that slight variations in angles α1, α2, α3 and α4 are possible and such variations are intended to be within the scope of the appended claims.

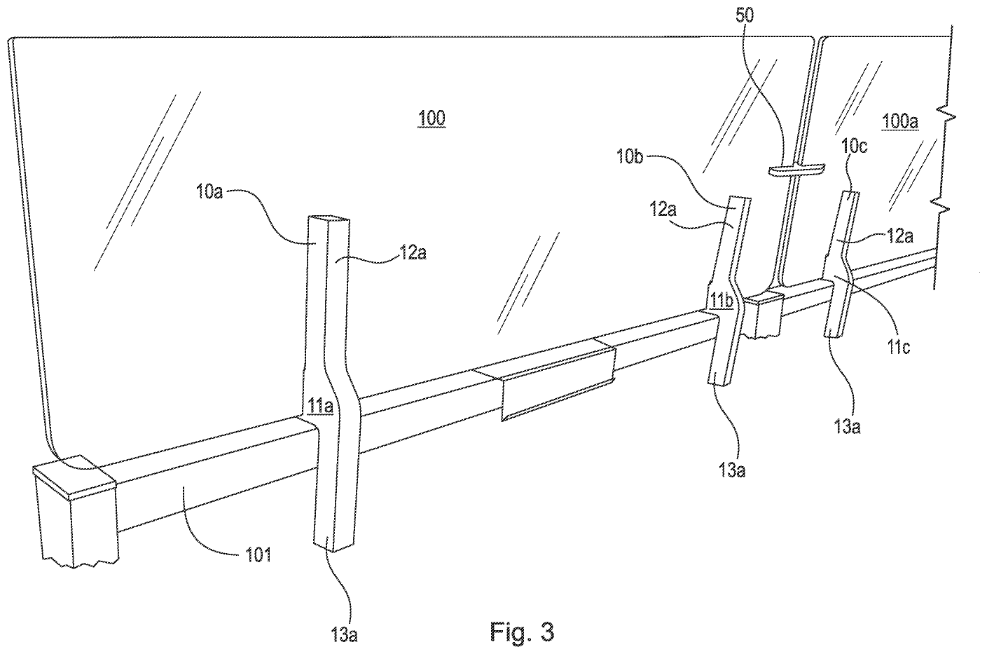

Partition mounting device 10 may be used in pairs, or in a greater number depending on the length of a partition barrier. In a preferred embodiment the number of partition mounting devices required is determined from a one-to-one ratio with the number of partition barrier slots, as shown in FIG. 3.

FIG. 3 shows a perspective view of the present invention engaged with a cubicle barrier wall and partition barriers. Cubicle wall 101 extends upwardly from a desk portion of a cubicle as commonly known in the art. To increase the protection from adjacent cubicles, partition mounting devices 10a, 10b, and 10c are used to secure partitions 100 and 100a to cubicle barrier wall 101. Lower trapezoidal channel 15 (shown in FIG. 1) of partition mounting devices 10a, 10b, and 10c engage the top surface of a cubicle barrier wall 101. First leg 13a of partition mounting devices 10a, 10b, and 10c are shown gripping one side of cubicle barrier wall 101 while second leg 13b of partition mounting devices 10a, 10b, and 10c grips of the opposite side of cubicle barrier wall 101 (not shown). A plurality of slots of partition barrier 100 and 100a are inserted into upper trapezoidal channel 14 (shown in FIG. 1) of partition mounting devices 10a, 10b, and 10c of pair of arms 12. Partition barrier 100 and 100a exerts a frictional force between one of the inside surfaces of lower trapezoidal channel 15 and a contacted cubicle barrier wall 101 side surface to hold the mounting device in place.

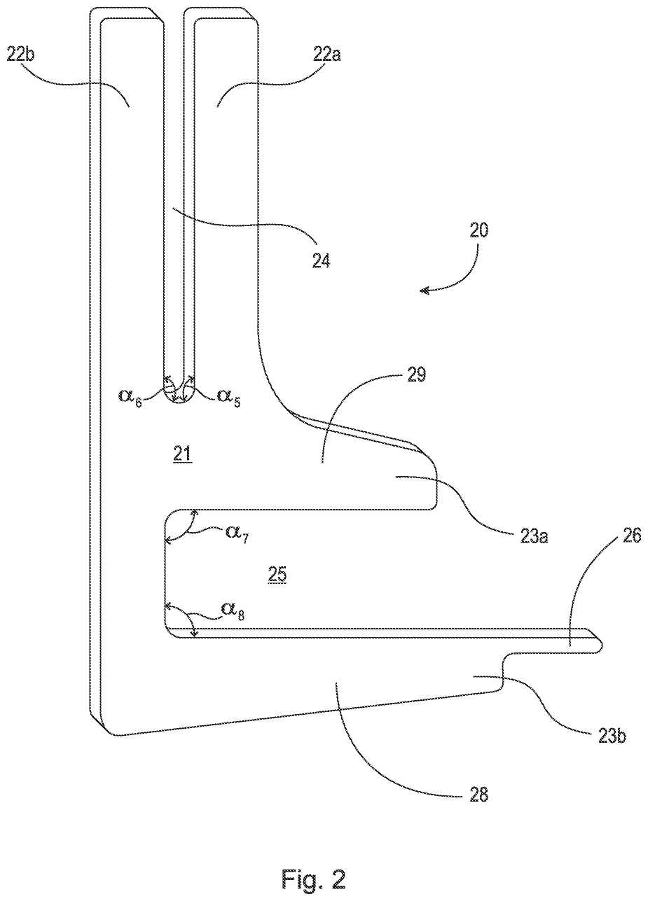

Adverting to FIG. 2, FIG. 2 is a front side view of a second embodiment of the present invention. Partition mounting device 20 is preferably configured to frictionally clamp a top and bottom surface of a desktop, however varying the width of the below-described channel allow partition mounting device 20 to adapt to a variety of fixtures, e.g., a countertop, an end table, a bar top, a reception desk, a work bench, etc.

Partition mounting device 20 comprises body 21, pair of arms 22, and pair of legs 23. In a preferred embodiment, body 21, arms 22a and 22b, and legs 23a and 23b comprise a single piece. The inside surfaces of first arm 22a and second arm 22b of partition mounting device 20 form upper trapezoidal channel 24 of partition mounting device 20. The distal ends of arms 22a and 22b are spaced apart at a shorter distance than the proximal ends fixedly secured to body 21. The distal end of channel 24 forms a rounded end that has a center point. In a preferred embodiment, angle α5 is 89° and is formed from the inside surface of arm 22a and the midpoint of channel 24 rounded end. In a preferred embodiment, angle α6 is 89° and is formed by the inside surface of arm 22b and the midpoint of channel 24 rounded end. Legs 23a and 23b of partition mounting device 20 are designated by long leg 28 (leg 23b) and short leg 29 (leg 23a). Long leg 28 terminates at the distal end to tab 26. Tab 26 is operatively arranged to accept a screw to threadably secure an engaged partition mounting device 20 to a desktop although tab be configured with a gripping surface to frictionally secure to a desktop. Legs 23a and 23b of partition mounting device 20 inside surface forms perpendicular trapezoidal channel 25. The distal ends of pair of legs 23 are spaced apart at a shorter distance than the proximal ends fixedly secured to body 21. In a preferred embodiment, angle α7 is 90° and is formed by the inside surface of leg 23a and the inside surface of channel 25. In a preferred embodiment, angle α8 is 87° and is formed by the inside surface of leg 23b and the inside surface of channel 25. Perpendicular trapezoidal channel 25 is operatively arranged to slidably engage a desktop surface contacting the proximate side surface of body 21. The distal ends of legs 23a and 23b create a greater force of friction on the top and bottom surfaces of a desktop compared to the proximal ends of legs 23a and 23b. Upper trapezoidal channel 24 is operatively arranged to accept and engage a partition barrier slot, preferably a width that is substantially the same as body 21 width. It should be appreciated that slight variations in angles α5, α6, and α8 are possible and such variations are intended to be within the scope of the appended claims.

Partition mounting device 20 may be used in pairs, or in a greater number, depending on the length, height and weight of a partition barrier to be secured. In a preferred embodiment, the number of partition mounting devices used is a one-to-one ratio with the number of partition barrier slots, similar to partition mounting device 10 shown in FIG. 3. When perpendicular trapezoidal channel 25 of partition mounting device 20 is slidably engaged to a desktop bottom surface and top surface, a partition barrier slot is then inserted into upper trapezoidal channel 24. The height and force of a partition barrier wall creates a force between one of the inside surfaces of perpendicular trapezoidal channel 25 and a contacts a desktop bottom or top surface cubicle barrier wall side surface, increasing the frictional resistance of an engaged perpendicular trapezoidal channel 15.

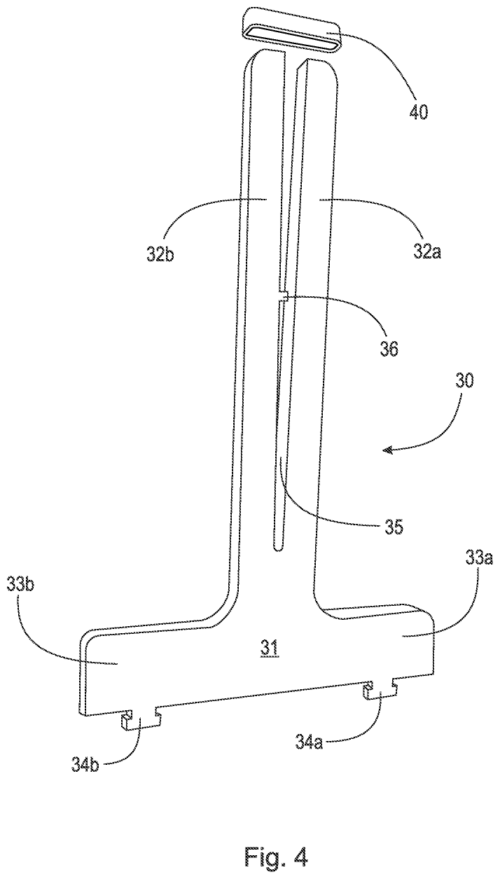

FIG. 4 shows a front view of a third embodiment of the present invention. Partition mounting stand 30 comprises body 31, arms 32a and 32b, legs 33a and 33b, feet 34a and 34b, and locking collar 40. In a preferred embodiment body 31, arms 32a and 32b, legs 33a and 33b, and feet 34a and 34b of partition mounting stand 30 are a singular piece. Feet 34a and 34b extend perpendicularly outward relative to legs 33a and 33b. Arms 32a and 32b form v-shaped channel 35 arranged to accept a partition barrier. An engaged partition barrier within v-shaped channel 35 is secured by locking collar 40. Locking collar 40 is arranged to slidably surround a compressed v-shaped channel 35, preventing an engaged partition barrier from being removed without disengaging locking collar 40. Partition mounting stand 30 may also comprise tab 36 that is arranged to fit a through-bore in a partition barrier to ensure a greater engagement. Partition mounting stand 30 is arranged to stand on a flat surface. Arms 32a and 32b may be of any length suitable to accommodate a variety of sized partition panels. Legs 33a and 33b, and feet 34a and 34b may be of a greater length to accommodate for a greater length of arms 32a and 32b in order to maintain partition mounting stand 30 in an upright position while engaging a partition barrier.

Partition mounting stand 30 may be used in pairs, or in a greater number, depending on the length, height and weight of a partition barrier to be secured. In a preferred embodiment, the number of partition mounting devices used is a one-to-one ratio with the number of partition barrier slots, similar to the arrangement of partition mounting device 10 shown in FIG. 3.

The present invention also comprises a method of manufacturing a partition mounting device. First an installation kit is sent to an end-user requesting partitions 100 (FIG. 3) and mounting devices 10 or 20 (FIGS. 1 and 2). The kit includes an illustrative example of a workstation that the end-user is requesting to be outfitted with the partitions and a pair of calipers. The illustration also includes fields of measurements that are to be completed by the end-user. The end-user then measures the thickness of cubicle wall 101 or any other wall that is being outfitted with the calipers provided and records the measurements in the illustration's fields. While the calibers are affixed to cubicle wall 101 for measuring, or any other objects present in the workstation, the end-user will photograph the calibers and send back the photographs of the measurements and the recorded measurements on the illustration. Once the measurements and photographs are received by the manufacture, the partition mounting device is manufactured to the exact specifications provided by the end-user.

Thus, it is seen that the objects of the invention are efficiently obtained, although it should be apparent that alternative embodiments of the invention are possible and intended to be within the scope of the appended claims.

### REFERENCE NUMERALS

10 partition mounting device
10a partition mounting device
10b partition mounting device
10c partition mounting device
11 body of partition mounting device 10
11a body of partition mounting device 10a
11b body of partition mounting device 10b
11c body of partition mounting device 10c
12a first arm of partition mounting device 10
12b second arm of partition mounting device 10
13a first leg of partition mounting device 10
13b second leg of partition mounting device 10
14 upper trapezoidal channel of partition mounting device 10
15 lower trapezoidal channel of partition mounting device 10
20 partition mounting device
21 body of partition mounting device 20
22a first arm of partition mounting device 20
22b second arm of partition mounting device 20
23a first leg of partition mounting device 20
23b second leg of partition mounting device 20
24 upper trapezoidal channel of partition mounting device
25 perpendicular trapezoidal channel of partition mounting device
26 tab of partition mounting device
28 long leg of partition mounting device
29 short leg of partition mounting device
30 partition mounting stand
31 body of partition mounting stand 30
32a first arm of partition mounting stand 30
32b second arm of partition mounting stand 30
33a first leg of partition mounting stand 30
33b second leg of partition mounting stand 30
34a first foot of partition mounting stand 30
34b second foot of partition mounting stand 30
35 v-shaped channel of partition mounting stand 30
36 tab of partition mounting stand 30
40 locking collar of partition mounting stand
50 clip
100 partition barrier
100a partition barrier
101 cubicle wall barrier
α1 inside angle of channel 14
α2 inside angle of channel 14
α3 inside angle of channel 15
α4 inside angle of channel 15
α5 inside angle of channel 24
α6 inside angle of channel 24
α7 inside angle of channel 25
α8 inside angle of channel 25

What is claimed is:

1. A partition mounting device, comprising:
a body;
a pair of arms extending upwardly from said body;
a pair of legs extending downwardly from said middle body;
an upper trapezoidal-shaped channel formed between and by said pair of arms; and,
a lower trapezoidal-shaped channel formed between and by said pair of legs.

2. The partition mounting device recited in claim 1 wherein each leg of said pair of legs is substantially of identical length to the remaining leg of said pair of legs.

3. The partition mounting device recited in claim 1 wherein each arm of said pair of arms is of substantially of identical length to the remaining arm of said pair of arms.

4. The partition mounting device recited in claim 1 where each leg of said pair of legs is longer in length than each arm of said pair of arms.

5. The partition mounting device recited in claim 1 wherein said lower trapezoidal-shaped channel is wider than said upper trapezoidal-shaped channel.

6. A partition mounting device, comprising:
a body;
a pair of arms extending upwardly from said body;
a pair of legs extending perpendicularly from said body;
an upper trapezoidal-shaped channel formed between and by said pair of arms; and,
a perpendicular trapezoidal-shaped channel formed between and by said pair of legs.

7. The partition mounting device recited in claim 6 wherein each arm of said pair of arms is of substantially of identical length to the remaining arm of said pair of arms.

8. The partition mounting device recited in claim 6 wherein the distal leg of said pair of arms is of longer length to the remaining leg of said pair of legs.

9. The partition mounting device recited in claim 6 wherein said lower trapezoidal-shaped channel is wider than said upper trapezoidal-shaped channel.

10. The partition mounting device recited in claim 7 wherein said distal leg comprises a tab.

11. The partition mounting device recited in claim 1 wherein said upper trapezoidal-shaped channel is operatively arranged to accept a partition panel and said lower trapezoidal-shaped channel is operatively arranged to slidably attach atop a cubicle wall.

12. The partition mounting device recited in claim 6 wherein said upper trapezoidal-shaped channel is operatively arranged to accept a partition panel and said perpendicular trapezoidal-shaped channel is operatively arranged to slidably attach to a desktop side surface.

13. The partition mounting device recited in claim 1 is comprised of high-density polyethylene.

14. The partition mounting device recited in claim 6 is comprised of high-density polyethylene.

15. The partition mounting device recited in claim 1 is comprised of a single piece.

16. The partition mounting device recited in claim 6 is comprised of a single piece.

17. An office furniture partition mounting assembly, comprising:
a partition;
a partition mounting device, wherein said mounting device comprises:
a body;
a pair of arms extending upwardly from said body;
a pair of legs extending downwardly from said middle body;
an upper trapezoidal-shaped channel formed between and by said pair of arms and arranged to hold and secure said partition; and,
a lower trapezoidal-shaped channel formed between and by said pair of legs and arranged to hold and secure a part of said office furniture.

18. A partition mounting stand, comprising:
a partition;
a partition mounting device, wherein said partition mounting device comprises:
a body;
a pair of arms extending upwardly from said body;
a pair of legs extending outwardly from said middle body;
a pair of feet extending perpendicularly outward from said pair of legs;
a v-shaped channel formed between and by said pair of arms and arranged to hold and secure said partition; and,
a locking collar arranged to slidably engage said v-shaped channel at the distal end compressing said v-channel to contact said partition.

19. A method of manufacturing a partition mounting device, comprising the steps of:
sending an installation kit to an end-user of said mounting device, said kit comprising:
an illustration of a typical workstation to be outfitted with one or more partitions, said illustration containing fields for said end-user to enter certain workstation dimensions; and,
a pair of calipers;
measuring thickness of a partition to which said partition mounting device will be affixed with said pair of calipers, where said measuring is performed by said end-user;
photographing said pair of calipers in place while measuring said thickness of said partition to which said partition mounting device will be affixed, where said photographing is performed by said end-user;
receiving said dimensions, measurements and photograph(s) from said end-user; and,
manufacturing said partition mounting device according to dimensions and measurements provided by said end-user.
